(19) United States
(12) Patent Application Publication
(10) Pub. No.: US 2010/0205561 A1
(43) Pub. Date: Aug. 12, 2010

(54) MOUSE HAVING SCREEN CAPTURE FUNCTION

(75) Inventors: Xian-Hao Chen, Taipei (TW); Qiang-Qiang Wang, Taipei (TW)

Correspondence Address: KIRTON AND MCCONKIE, 60 EAST SOUTH TEMPLE,, SUITE 1800, SALT LAKE CITY, UT, 84111, US

(73) Assignee: PRIMAX ELECTRONICS LTD., Taipei (TW)

(21) Appl. No.: 12/414,483

(22) Filed: Mar. 30, 2009

(30) Foreign Application Priority Data
Feb. 6, 2009 (TW) 098103828

(51) Int. Cl. G06F 3/048; G09G 5/08

(52) U.S. Cl. 715/809; 715/810; 345/163

(57) ABSTRACT

A mouse having a screen capture function is provided. The mouse includes a first button and a screen capture function triggering button. A mouse driver including a screen capture program is installed in the computer host. When the screen capture function triggering button is depressed, the screen capture program is activated. In response to a first button signal generated from the first button, an image of a selected area on the screen is captured.

### FIELD OF THE INVENTION

The present invention relates to an input device, and more particularly to an input device capable of implementing a screen capture function.

### BACKGROUND OF THE INVENTION

With rapid development of electronic and information industries, computers and the peripheral device thereof become essential parts in our daily lives. A typical computer system includes a computer host, an input device and a display device. The input device and the screen are connected with the computer host. The computer host can execute various application programs. Via a computer interface, images generated from the computer host can be displayed on a screen of the display device. The input device plays an important role in establishing contact between the computer host and the users. The common input device includes for example a mouse, a keyboards or a trackball.

For example, a keyboard usually includes a plurality of keys. When some keys are depressed, corresponding characters, numbers or signs are produced. Alternatively, depressing other keys or simultaneous key can produce actions or computer commands. For example, when a print screen key is depressed, an image of the current screen that is connected to the computer host is captured. Then, the image of the current screen can be pasted into a Microsoft Paint document, a Microsoft Word document or a Microsoft PowerPoint document.

Nowadays, with increasing development of communication technologies, people usually communicate with each other by electronic mails and telephones in viewing working or other purposes. For example, when a teleconferencing meeting is held, some important images usually need to be transmitted to the attendants in order to facilitate the attendants to discuss the subject matters. Generally, these images are inserted into electronic mails, which are then transferred to the attendants through internet connection. Since the teleconferencing meeting is not a face-to-face business meeting, the attendants usually fail to understand the current subject matter according to the images. For allowing the attendants to realize the current subject matter, it is very import to properly utilize the screen capture function.

For example, after an image to be discussed in the teleconferencing meeting is shown on a screen, the user may firstly depress the print screen key to copy an image of the current screen, open a Microsoft Paint document, and then paste the image of the current screen into the Microsoft Paint document. Since depressing the print screen key will capture the entire screen, the image of the entire screen needs to be further processed. For example, the border of the captured image needs to be deleted, and the pencil function of the graphics painting program Microsoft Paint is used to mark some portions of the image required for paying attention or avoiding confusion. The processed image could be sent out via electronic mails without the need of explaining the image. In other words, the screen capture function is effective for holding teleconferencing meetings or sending electronic mails.

The screen capture function of the prior art, however, still has some drawbacks. For example, Microsoft Paint is necessary for marking specified portions or defining a selected area of the image when the screen capture function is done. Moreover, since depressing the print screen key captures the entire screen, the processes of deleting the border, opening the Microsoft Paint and deleting the undesired portions of the image of the entire screen are very complicated and time-consuming.

### SUMMARY OF THE INVENTION

It is an object of the present invention to provide a mouse having a screen capture function.

In accordance with an aspect of the present invention, there is provided a mouse having a screen capture function. The mouse generates a cursor moving signal to control a cursor on a screen that is connected to a computer host. The mouse includes a first button and a screen capture function triggering button. The first button is used for generating a first button signal. The screen capture function triggering button is used for generating a screen capturing signal. The screen capturing signal includes a mouse identification code and an activating signal. A mouse driver including a screen capture program is installed in the computer host. When the screen capturing signal is received by the mouse driver, the screen capture program is activated to implement the following steps. Firstly, the first button signal is received and a selected area is defined on the screen in response to the cursor moving signal. When a copying signal generated from the mouse is received, an image of the selected area is copied.

In an embodiment, the first button is a left button of the mouse.

In an embodiment, the copying signal is a clicking signal generated when the cursor is located within the selected area and the left button of the mouse is depressed.

In an embodiment, the mouse further includes a second button for generating a second button signal.

In an embodiment, the second button is a right button of the mouse.

In an embodiment, a computer interface menus with multiple function items is created when the second button signal is received by the computer host.

In an embodiment, the function items of the computer interface menus include a cutting function item, a copying function item and a pasting function item.

In an embodiment, the image of the selected area is pasted into a Microsoft Word document, a Microsoft PowerPoint document or a Microsoft Paint document after the image of the selected area is copied.

In an embodiment, a screen capture menu bar with multiple function items is shown at a side of the selected area when the selected area is defined.

In an embodiment, the function items include a mouse writing function item, an arrow generating function item, an input text function item, a new file saving function item and a color picking function item.

In an embodiment, a color change dialog box is created when the color picking function item is selected. Via the color change dialog box, a color of a mouse writing sign, an arrow or a text generated through the mouse writing function item, the arrow generating function item or the screen capture menu bar is changeable.

In an embodiment, a new file saving function is enabled when the new file saving function item is selected, and the image of the selected area is saved as a PNG image file, a JPEG image file, a BMP image file or a GIF image file.

In an embodiment, a disabling signal is generated immediately after the image of the selected area is copied. In response to the disabling signal, the screen capture program is disabled.

In an embodiment, a disabling signal is generated after the screen capture program is activated and the screen capture function triggering button is depressed again. In response to the disabling signal, the screen capture program is disabled.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic perspective view illustrating a computer system using the mouse of the present invention;

FIG. 2 is a schematic view illustrating a selected area defined on the screen by a mouse of the present invention and a screen capture menu bar with multiple function items according to an embodiment of the present invention;

FIG. 3 is a schematic view illustrating the use of the mouse of the present invention to implement a mouse writing function and an arrow generating function so as to generate a mouse writing sign and an arrow on the selected area of the screen;

FIG. 4 is a schematic view illustrating the use of the mouse of the present invention to implement a text input function so as to input a text on the selected area of the screen;

FIG. 5 is a schematic view illustrating the use of the mouse of the present invention to implement a color picking function so as to change the color of the selected area of the screen;

FIG. 6 is a schematic view illustrating the use of the mouse of the present invention to implement a new file saving function so as to save the image of the selected area as an image file;

FIG. 7 is a schematic view illustrating the use of the mouse of the present invention to create a computer interface menus with multiple function items; and

FIG. 8 is a schematic view illustrating the use of the mouse of the present invention to paste the image of the selected area into a document file.

### DETAILED DESCRIPTION OF THE PREFERRED EMBODIMENT

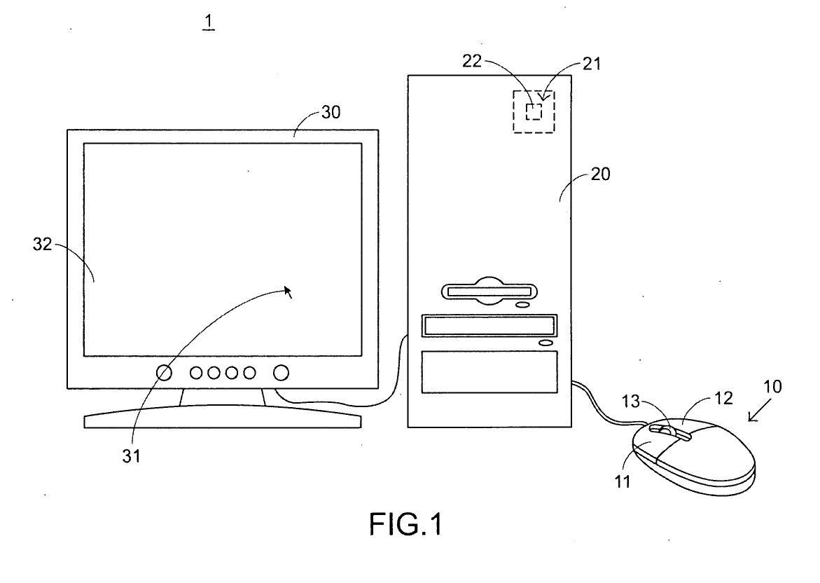

For meeting the marketable demands, the present invention provides a mouse having a screen capture function. FIG. 1 is a schematic perspective view illustrating a computer system using the mouse of the present invention. As shown in FIG. 1, the computer system 1 principally comprises a mouse 10, a computer host 20 and a display device 30. The mouse 10 and the screen 30 are connected with the computer host 20. The computer host 20 can execute various application programs. Via a computer interface (e.g. a Microsoft Windows system), images generated from the computer host 20 can be displayed on a screen 32 of the display device 30. The mouse 10 can control movement of a cursor 31 that is shown on the screen 32. The mouse 10 includes a first button 11, a second button 12 and a screen capture function triggering button 13. When the first button 11 is depressed, a first button signal is generated. When the second button 12 is depressed, a second button signal is generated. When the screen capture function triggering button 13 is depressed, a screen capturing signal is generated. The first button signal, the second button signal and the screen capturing signal are transmitted to the computer host 20, thereby executing corresponding instructions. In this embodiment, the first button 11 and the second button 12 are the left button and the right button of the mouse 10, respectively.

A mouse driver 21 has been previously installed in the computer host 20 for driving specified functions of the mouse 10. The mouse driver 21 includes a screen capture program 22 for providing a screen capture function. When the screen capturing signal transmitted from the mouse 10 is received by the computer host 20, the screen capture program 22 is activated. The screen capturing signal includes a mouse identification code and an activating signal. The mouse identification code indicates the identity of the mouse 10. According to the mouse identification code, the computer host 20 can recognize whether the mouse 10 has been activated by the mouse driver 21. In response to the activating signal, the screen capture program 22 is activated. It is noted that, the screen capture program 22 is activated after the mouse identification code and the activating signal included in the screen capturing signal are received by the computer host 20 and the identity of the mouse 10 is recognized. In other words, if the screen capturing signal is not generated from the mouse 10 that is driven by the mouse driver 21 according to the mouse identification code included in the screen capturing signal, the screen capture program 22 will not be activated by the computer host 20.

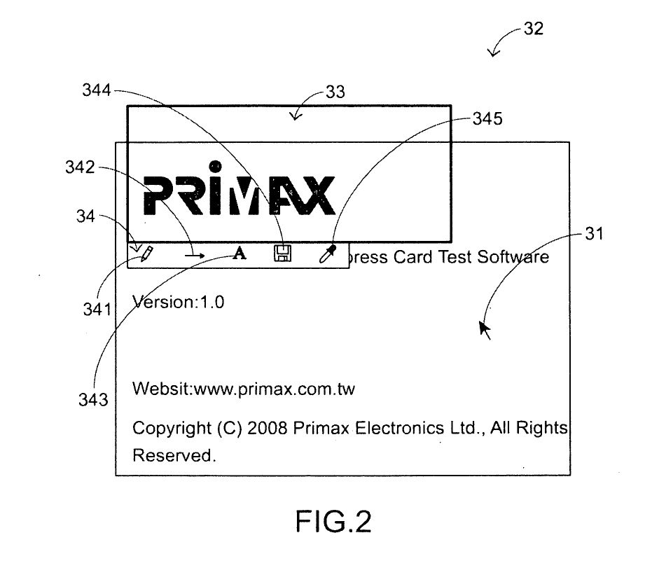

FIG. 2 is a schematic view illustrating a selected area defined on the screen by a mouse of the present invention and a screen capture menu bar with multiple function items according to an embodiment of the present invention. For implementing the screen capture function, an image file to be captured is opened and then displayed on the screen 32. After the image file is opened, the user may depress the screen capture function triggering button 13 of the mouse 10, so that a screen capturing signal is transmitted from the mouse 10 to the computer host 20. In response to the screen capturing signal, the computer host 20 will activate the screen capture program 22. In this embodiment, the screen capture function triggering button 13 is a scroll wheel of the mouse. When the scroll wheel is depressed, a wheel button function is enabled and thus the screen capture program 22 is activated.

After the screen capture program 22 is activated, the user can locate the cursor 31 at a first position of the screen 32, then depresses the first button 11 (i.e. the left button) to generate a first button signal, and finally move the cursor 31 to a second position of the screen 32 to generate a cursor moving signal. In response to the first button signal and the cursor moving signal, the screen capture program 22 will define a selected area 33 on the screen 32. At the same time, a screen capture menu bar 34 is shown at the bottom side or other side of the selected area 33. The screen capture menu bar 34 includes multiple function items. The function items of the screen capture menu bar 34 include for example a mouse writing function item 341, an arrow generating function item 342, an input text function item 343, a new file saving function item 344 and a color picking function item 345. After the selected area 33 and the screen capture menu bar 34 are shown on the screen 32, associated post-processing operations can be implemented according to the practical requirements.

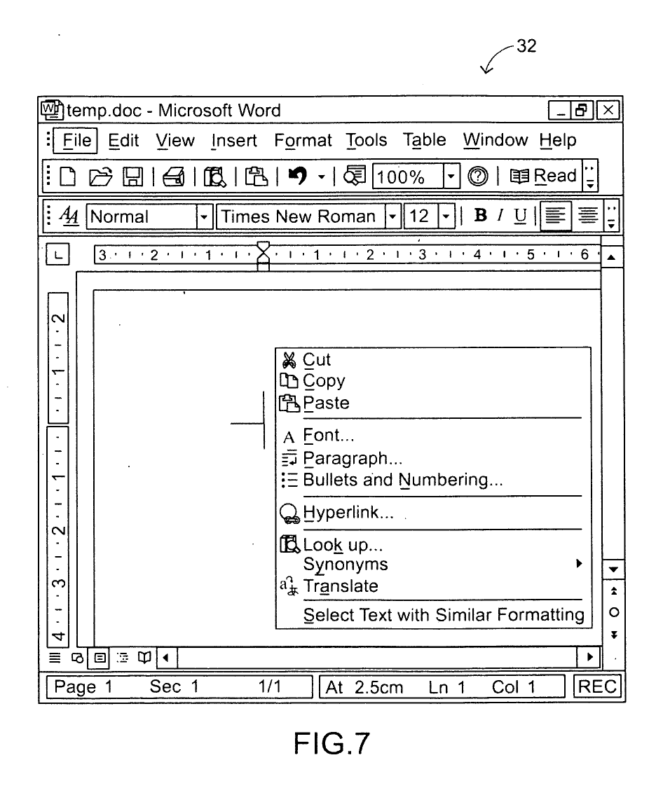

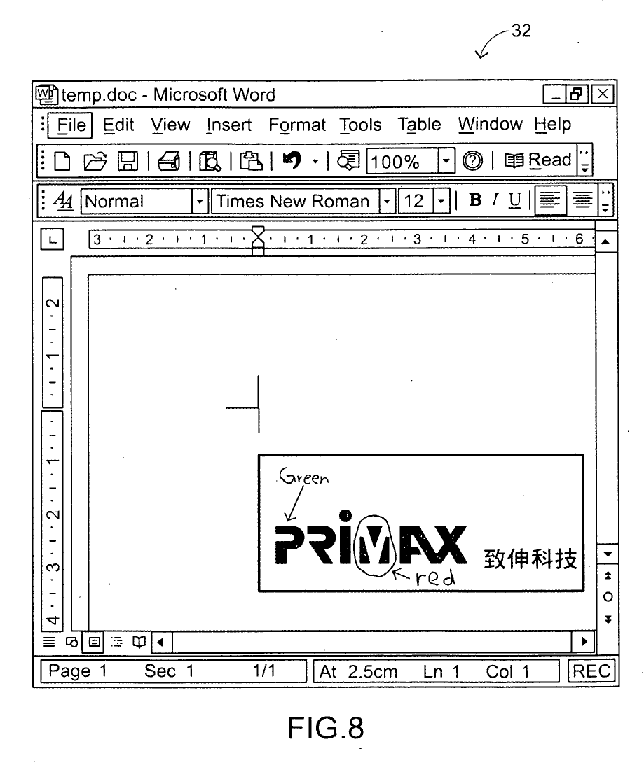

For example, in order to perform a copying function, the user can move the cursor 31 to the selected area 33, and then depresses the left button 11 to generate a copying signal. The copying signal is a clicking signal generated when the left button 11 is depressed. In response to the copying signal, a copy of the selected area 33 is created. After a copy of the selected area 33 is created, the user can open another document file (e.g. a Microsoft Word document). Next, the user can move the mouse 10 to locate the cursor at a specified position of the Microsoft Word document. Next, the second button 12 (i.e. the right button) is depressed to generate a second button signal. In response to the second button signal, a computer interface menus with multiple function items is shown on the Microsoft Word document (see FIG. 7). The function items of the computer interface menus include for example a cutting function item, a copying function item, a pasting function item and the like. Next, the cursor is locked on the pasting function item and the left button is depressed on the pasting function item, so that the selected area 33 is pasted into the Microsoft Word document (see FIG. 8). The above discussion is related to a process of using the mouse of the present invention to capture a selected area 33 of the screen 32 and paste the image of the selected area 33 into the Microsoft Word document. Other functions of using the mouse of the present invention will be illustrated in more details as follows.

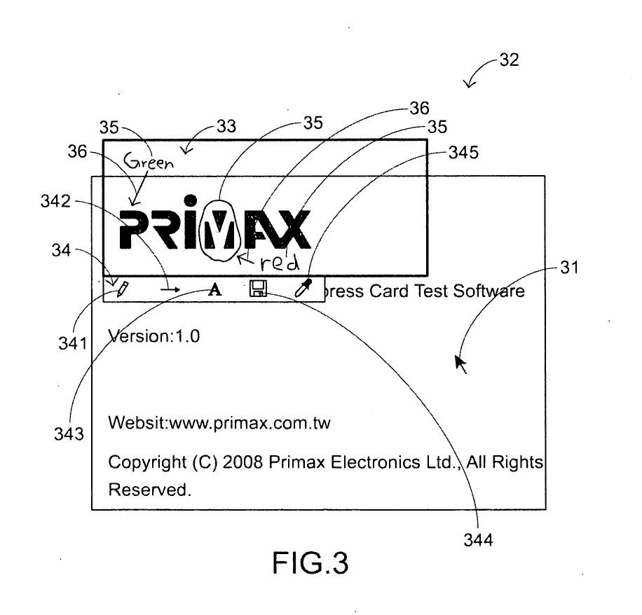

Please refer to FIG. 2 again. For example, after the selected area 33 and the screen capture menu bar 34 are shown on the screen 32, the user can select the arrow generating function item 342 from the screen capture menu bar 34 such that the arrow generating function is enabled. The user can locate the cursor 31 at a first position of the selected area 33, then depress the left button 11, and finally move the cursor 31 to a second position of the selected area 33. Meanwhile, an arrow 36 is generated (see FIG. 3). The length of the arrow 36 is dependent on the duration of continuously depressing the left button 11. The arrow 36 can facilitate the user to indicate some special parts of the selected area 33. Furthermore, when the user selects the mouse writing function item 341 from the screen capture menu bar 34, the mouse writing function is enabled. By continuously depressing the left button 11 and moving the cursor 31, a mouse writing sign 35 (e.g. a writing character “Green” or “Red”) is created on the selected area 33 (see FIG. 3).

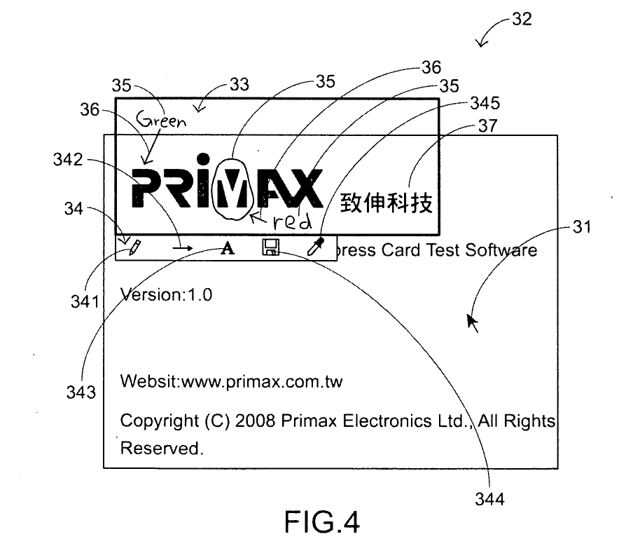

Furthermore, when the user selects the input text function item 343 from the screen capture menu bar 34, the input text function is enabled. The user can locate the cursor 31 at a specified position of the selected area 33, then depress the left button 11, and finally input a text 37 at the position where the left button 11 is depressed (see FIG. 4).

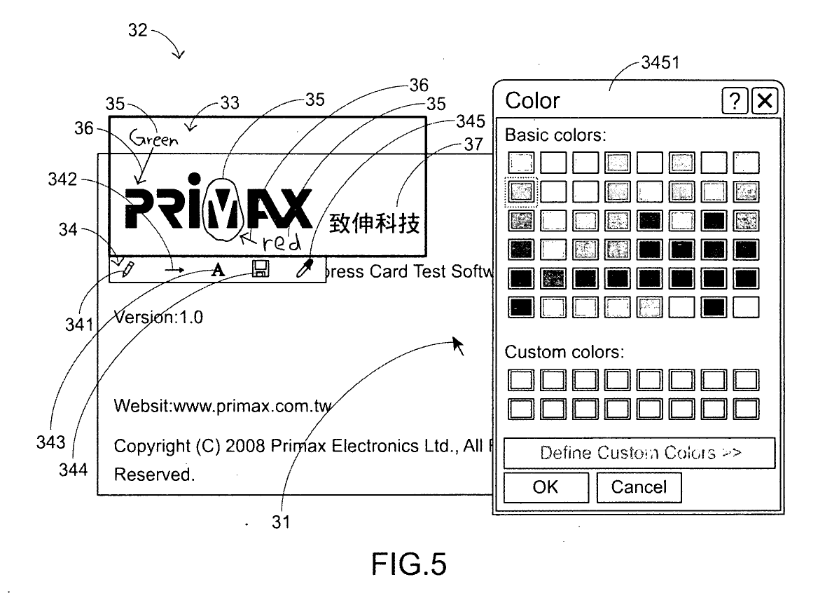

FIG. 5 is a schematic view illustrating the use of the mouse of the present invention to implement a color picking function so as to change the color of the selected area of the screen. By the color picking function, the colors of the mouse writing sign 35, the colors of the arrow 36 and the text 37 that are respectively generated through the mouse writing function item 341, the arrow generating function item 342 and the screen capture menu bar 34 are changeable. When the user selects the color picking function item 345 from the screen capture menu bar 34, the color picking function is enabled. After the color picking function is enabled, a color change dialog box 3451 is created. By moving the cursor 31 to select desired colors from the color change dialog box 3451, the mouse writing sign 35, the arrow 36 and the text 37 will be painted with distinguishable colors in order to prevent from confusion.

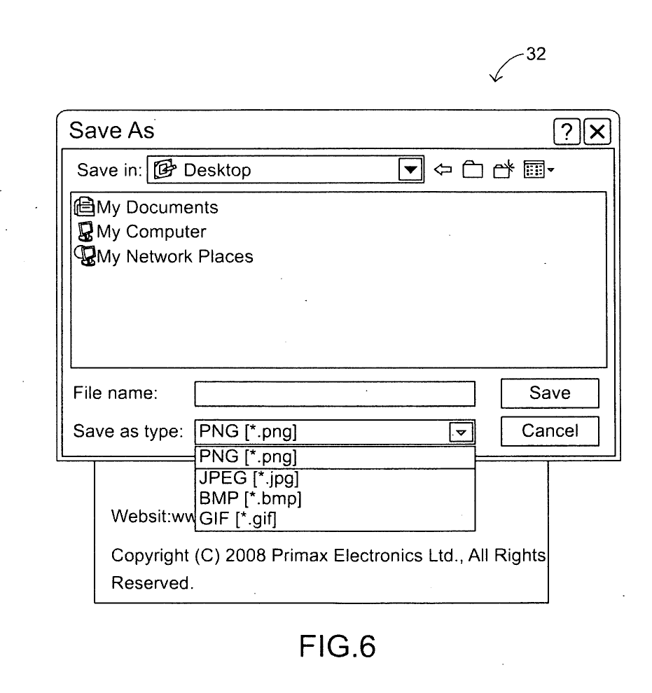

After the above post-processing operations on the selected area 33 are implemented, the user can move the cursor 31 to the selected area 33 that has been processed, and then depresses the left button 11 to generate a copying signal. Next, the image of the selected area 33 is pasted into a document file. An example of the document file includes but is not limited to a Microsoft Paint document, a Microsoft Word document or a Microsoft PowerPoint document. Alternatively, the user can select the new file saving function item 344 from the screen capture menu bar 34, and thus the image of the selected area 33 that has been processed will be saved as an image file. The type of the image file includes but is not limited to a PNG image file, a JPEG image file, a BMP image file or a GIF image file (see FIG. 6).

When the screen capture program 22 is activated, the user may depress the screen capture function triggering button 13 of the mouse 10 again, so that a disabling signal is transmitted from the mouse 10 to the computer host 20. In response to the disabling signal, the screen capture program 22 is disabled. Alternatively, the disabling signal is generated immediately after the selected area 33 is copied, so that the screen capture program 22 is disabled and then the image of the selected area 33 could be pasted into the document file. Moreover, for preventing from erroneously depressing the screen capture function triggering button 13 to disable the screen capture program 22, a disabling confirmation dialog box (not shown) is created on the screen 32 when the disabling signal is generated. Via the disabling confirmation dialog box, the user may decide whether the screen capture program 22 is disabled or not.

From the above description, the screen capture program installed in the computer host is activated when the screen capture function triggering button of the mouse of the present invention is depressed. By using the mouse to control the cursor, a selected area is defined on the screen and associated post-processing operations can be performed on the selected area. Since the operations of the screen capture program are similar to the simple graphics painting program Microsoft Paint, the use of the mouse of the present invention to execute the screen capture program is very easy. Since the mouse of the present invention is capable of implementing a screen capture function, the image of the selected area can be directly copied without the need of deleting the undesirable border. Therefore, the method of implementing the screen capture function by using the mouse of the present invention is simplified and time-saving, thereby solving the problems encountered from the prior art.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A mouse having a screen capture function, said mouse generating a cursor moving signal to control a cursor on a screen that is connected to a computer host, said mouse comprising:
a first button for generating a first button signal; and
a screen capture function triggering button for generating a screen capturing signal, said screen capturing signal including a mouse identification code and an activating signal,
wherein a mouse driver including a screen capture program is installed in said computer host, and when said screen capturing signal is received by said mouse driver, said screen capture program is activated to implement steps of:
receiving said first button signal and defining a selected area on said screen in response to said cursor moving signal, and copying an image of said selected area when a copying signal generated from said mouse is received.

2. The mouse according to claim 1 wherein said first button is a left button of said mouse.

3. The mouse according to claim 2 wherein said copying signal is a clicking signal generated when said cursor is located within said selected area and said left button of said mouse is depressed.

4. The mouse according to claim 1 further comprising a second button for generating a second button signal.

5. The mouse according to claim 4 wherein said second button is a right button of said mouse.

6. The mouse according to claim 4 wherein a computer interface menus with multiple function items is created when said second button signal is received by said computer host.

7. The mouse according to claim 6 wherein said function items of said computer interface menus include a cutting function item, a copying function item and a pasting function item.

8. The mouse according to claim 6 wherein said image of said selected area is pasted into a Microsoft Word document, a Microsoft PowerPoint document or a Microsoft Paint document after said selected area is copied.

9. The mouse according to claim 1 wherein a screen capture menu bar with multiple function items is shown at a side of said selected area when said selected area is defined.

10. The mouse according to claim 9 wherein said function items include a mouse writing function item, an arrow generating function item, an input text function item, a new file saving function item and a color picking function item.

11. The mouse according to claim 10 wherein a color change dialog box is created when said color picking function item is selected, wherein a color of a mouse writing sign, an arrow or a text generated through said mouse writing function item, said arrow generating function item or said screen capture menu bar is changeable via said color change dialog box.

12. The mouse according to claim 10 wherein a new file saving function is enabled when said new file saving function item is selected, and an image of said selected area is saved as a PNG image file, a JPEG image file, a BMP image file or a GIF image file.

13. The mouse according to claim 1 wherein a disabling signal is generated immediately after said image of said selected area is copied, wherein said screen capture program is disabled in response to said disabling signal.

14. The mouse according to claim 1 wherein a disabling signal is generated after said screen capture program is activated and said screen capture function triggering button is depressed again, wherein said screen capture program is disabled in response to said disabling signal.
